(19) United States
(12) Patent Application Publication
(10) Pub. No.: US 2008/0104695 A1
(43) Pub. Date: May 1, 2008

(54) Device and Method for Controlling Access, Core with Components Comprising Same and Use Thereof

(76) Inventors: Jean-Philippe Fassino, Domene (FR); Tahar Jarboui, Grenoble (FR); Marc Lacoste, Grenoble (FR)

Correspondence Address: COHEN, PONTANI, LIEBERMAN & PAVANE, 551 FIFTH AVENUE, SUITE 1210, NEW YORK, NY, 10176, US

(21) Appl. No.: 11/792,900

(22) PCT Filed: Nov. 22, 2005
(86) PCT No.: PCT/FR05/02927

§ 371 Date: Jun. 11, 2007

(30) Foreign Application Priority Data
Dec. 9, 2004 (FR) 0413243

(51) Int. Cl. G06F 21/00

(52) U.S. Cl. 726/17

(57) ABSTRACT

An access control system and method, a component-based kernel including it, and its use. A compromise is achieved between security and reconfigurability while providing high security by combining, in a system for controlling access by subjects S to objects, whether secured or not, for operations mᵢⱼ, access control decision means (10) and an access protection mechanism (PA) that enables access to be authorized or denied depending on the validity of access capacities. The access control decision means (10) allocate capacities for access to non-secured objects and modify the validity of capabilities for access to secured objects based on access rights, said decision means (10) being implemented by the access protection mechanism (PA) if the access capabilities are invalid.

The invention relates to an access control system and method, to a component-based kernel including said access control system, and to its use in communication and/or broadcasting network station operating systems. The component-based kernel can in particular be used in operating systems of mobile telecommunication network user stations, known as terminals.

Telecommunication networks and terminals are increasingly dynamic: downloading code, customizable functions, etc. To address this, systems must be increasingly open, adaptable, and reconfigurable, which puts security at risk. Terminal reconfigurability has recently been extended to encompass the operating system, on which protection of the system as a whole is based. Protecting network and terminal resources is therefore critical for service and infrastructure providers if they are to earn and keep the confidence of their customers.

Mechanisms for enforcing the security policy of the system grouping together all elements critical to network and terminal security (known as the confidence base) must guarantee the following properties:
security: no illegitimate access to resources; no bypassing of security systems whose integrity must be assured (complete mediation); no abusive propagation of administrator or supervisor access rights (lower privilege);
minimum impact on performance;
flexibility: support for more than one security policy; variable granularity access control; dynamic management of access rights;
simple design, use, and administration;
confidence: a small, simple confidence base, which it must be possible for a trusted third party to certify as correct.

It is difficult to find a fair balance between these often mutually-contradictory properties.

Compromises have nevertheless already been proposed, and have proved more or less satisfactory as a function of the design parameters used: type of kernel, security model, location of the protection mechanism. The emphasis in onboard systems, in particular in mobile telecommunication network terminals, is currently on expandable kernels with a single addressing space, for example SPIN: easy to reconfigure, easier to certify (minimal kernels containing only indispensable services), but vulnerable to attack. Component-based kernels such as Think, described in the paper “Think: a Software Framework for Component-Based Operating System Kernels” by J. P. Fassino, J. B. Stefani, J. Lawall, and G. Muller, USENIX Annual Technical Conference, June 2002, provide greater flexibility by means of a more homogeneous architecture model: the whole of the kernel is assembled from individual reconfiguration units, i.e. components. The performance obtained is comparable to that of standard systems. However, these kernels offer nothing in terms of security. Access policies intended to make them more secure have explored many security properties, from confidentiality or integrity to separation of privileges. The multiplicity of models reflects a lack of consensus, which is addressed by policy-neutral authorization mechanisms. The benefit lies in being able to support multiple policies and federate them using a common mechanism, for example the component-based kernel security architecture of T. Jarboui, J. P. Fassino, and M. Lacoste described in the paper “Reconfigurable Access Control for Component-Based OS Kernels”, E2R Workshop on Reconfigurable Mobile Systems and Networks beyond 3G, IEEE International Symposium on Personal, Indoor and Mobile Radio Communications, September 2004. Different locations of the protection mechanism have been envisaged in order to optimize the compromise between the various properties to be guaranteed: at the hardware level (for example a memory management unit (MMU) provides confinement of applications by defining addressing spaces) or using secure languages, such as Java, that provide complete mediation and offer relatively flexible solutions for easy implementation of fine-grain access control that is relatively weak from the security point of view. The closer the protection mechanism to the kernel, the more secure the system (because it is less likely that the mechanism will be bypassed) but, in contrast, the more complex the reconfiguration process.

Whether applied to monolithic kernels or microkernels, the protection techniques implemented in current operating systems essentially rely on the addressing space concept. Monolithic kernels suffer from complexity, which generates security weaknesses going as far as corruption of the operating system. Microkernels suffer from execution overheads that are incompatible with lightweight mobile terminals. Finally, these systems are characterized by the impossibility of providing fine-grain protection and the fixed nature of the security architectures (no choice of security mechanism location, making it impossible to adapt protection as a function of the required property: simple use, compatibility with existing code, performance or high security).

Of all the paths explored in recent years, the approach to access control as applied to component-based kernels described by T. Jarboui et al. (see above reference) seems to succeed in maintaining the delicate balance between reconfigurability and security. The proposed security model uses a reference monitor and a security policy manager, thus splitting access control between the decision-taking and implementation mechanisms. Fine-grain access control is achieved by distributing reference monitors between components. This architecture should instill confidence (minimal kernels), at the same time as allowing simple adaptation of the system to changes occurring during its life cycle without compromising its security, the component being both a security unit and a reconfiguration unit. However, apart from the multiplicity of reference monitors, this architecture has the drawback that it degrades performance because systematic control of access to resources involves the reference monitor, with no possibility of optimization, for example through hardware-only control. Moreover, with this approach, because it is still possible to forge memory references directly and to access all the data and code of the kernel, it is not possible to prevent bypassing, to make the reference monitor inviolable or to assure the integrity of the security policy manager.

The present invention achieves a compromise between high security and reconfigurability without recourse to the costly concept of addressing space. This compromise is achieved by combining access control decision means and an access protection mechanism for protecting access to a set of objects, whether they are secured or not.

One aspect of the invention is a system for controlling access by subjects to secured or non-secured objects for operations, the system comprising an access protection mechanism for authorizing or denying access by a requesting subject to an object depending on the validity of the corresponding capacity to access said object, and access control decision means for allocating capacities for access to a non-secured object and modifying the access capacities to a secured object as a function of the rights of the subject to access the object. The access protection mechanism prevents bypassing of the access control decision means by calling said access control decision means if the capacity to access an object is invalid. Diverse security policies can be supported because of this clear split between decision implementation by the access protection mechanism and decision making by the access control decision.

To enable fine-grain access control, the access control system can include means for intercepting requests to access certain predetermined objects.

The access protection mechanism can be a memory management unit (MMU) available off the shelf or a two-bit table with one bit representing the object reading capacity and the other bit representing the object writing capacity, which enables a compact representation of the security policy. Using a two-bit table rather than an MMU reduces manufacturing, use, and implementation costs at the same time as improving performance (by at least around 3% on modern processors). These advantages are especially critical in mobile onboard environments.

To go beyond fixed security architectures, and for security policy to be able to evolve, the access control decision means can add, modify, or eliminate access rights.

Another aspect of the invention is a method of controlling access to objects by subjects for operations, the method comprising the following steps:
receiving an access request from the subject;
protecting access by different means as a function of the validity of the capacity of the subject to access the object for the requested operation;
deciding to allocate the access capacity to the subject or not as a function of the right of the subject to access the object if the capacity is invalid.

Thus certain objects have high security and others reflect a compromise between reconfigurability and security.

In order to be able to provide fine-grain access control, the protection step can include, if the subject requests access for an operation to an object having operations that do not all have the same access rights:
intercepting the access request, enabling invocation of an access rights verification;
verifying the right of the subject to access the object for the requested operation, enabling a decision to validate the access capacity of the subject for said operation or not;
authorizing or denying access as a function of the validity of the access capacity; and
if the access request is authorized:
   executing the operation requested by the subject on the object; then
   revoking the validity of the capacity of the subject to access the object for the requested operation.

The invention further consists in a component-based kernel, each component including code and data, said kernel comprising:
the above system for controlling access to objects consisting of said;
control components consisting of objects having access capacities that are always invalid, one of said control components including the access control decision means of said access control system;
non-secured components having valid access capacities; and
secured components having particular access rights.

Using a component-based kernel ensures total control of the complexity of the system architecture in terms of implementation and configuration.

To enable the access protection hardware mechanism to assign and manipulate access rights and to detect access to objects with invalid capacities, the component-based kernel can be organized into a plurality of segments, each consisting of a continuous series of memory areas:
a supervisor segment including the code and data of the control components;
a segment including the interception means, the access capacities of the objects of this segment being read-only;
a code segment of the other components, the access capacities of the objects of this segment being read-only;
a data segment of the non-secured components, having object access capacities that are in read mode and in write mode;
a data segment for each heterogeneous secured component; and:
   either a data segment for each homogeneous secured component;
   or a data segment for each homogeneous secured component having the same access rights.

The invention also consists in a method of fabricating the above component-based kernel, the method comprising the following steps:
dividing a system into a plurality of components including code, data and one or more interfaces including operations;
defining a security policy;
creating a component including access control decision means having interfaces with interception means and an access protection mechanism, said interface with the interception means including operations of verifying and revoking rights of a subject to access a component;
classifying the components by the access control type required as a function of the security policy;
associating respective interception means with each heterogeneous secured component;
defining the organization of the memory into segments;
assembling all the components with the control components.

The invention proposes using this component-based kernel in communication network and/or multimedia data broadcasting station operating systems.

The features and advantages of the invention become more clearly apparent on reading the following description, which is given by way of example, and from the figures to which it refers, in which:

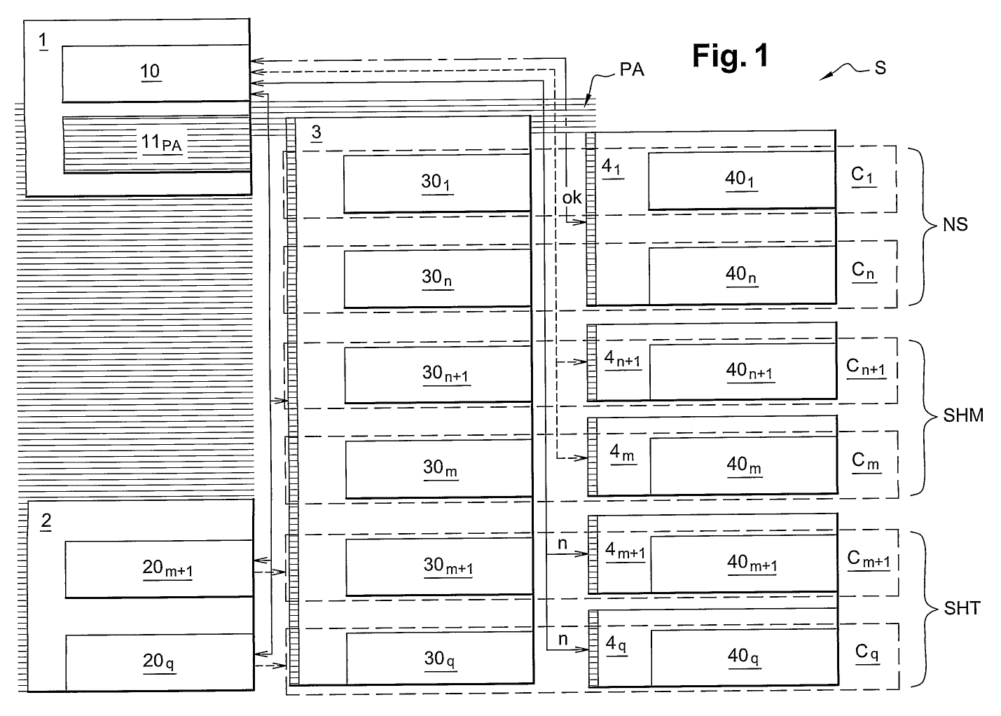

FIG. 1 is a block diagram showing a set of objects access to which is controlled by an access control system of the invention;

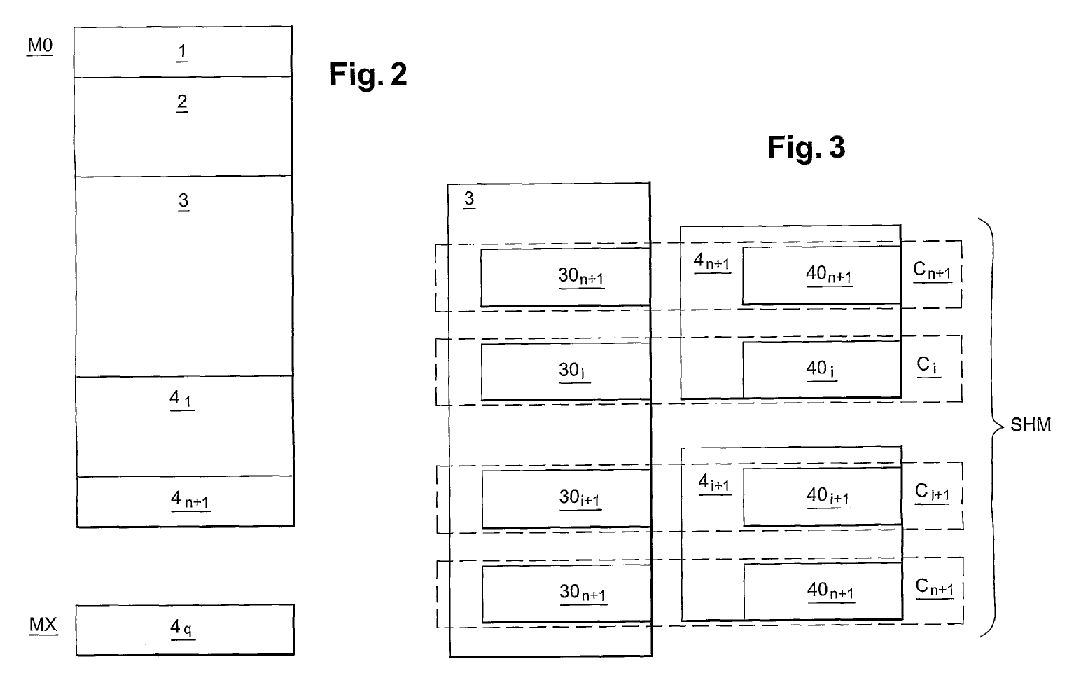

FIG. 2 shows an example of segmentation of a memory that contains objects and is used by an access protection mechanism of the access control system of the invention;

FIG. 3 shows a different example of segmentation in accordance with the invention of a portion of a memory containing homogeneous secured objects;

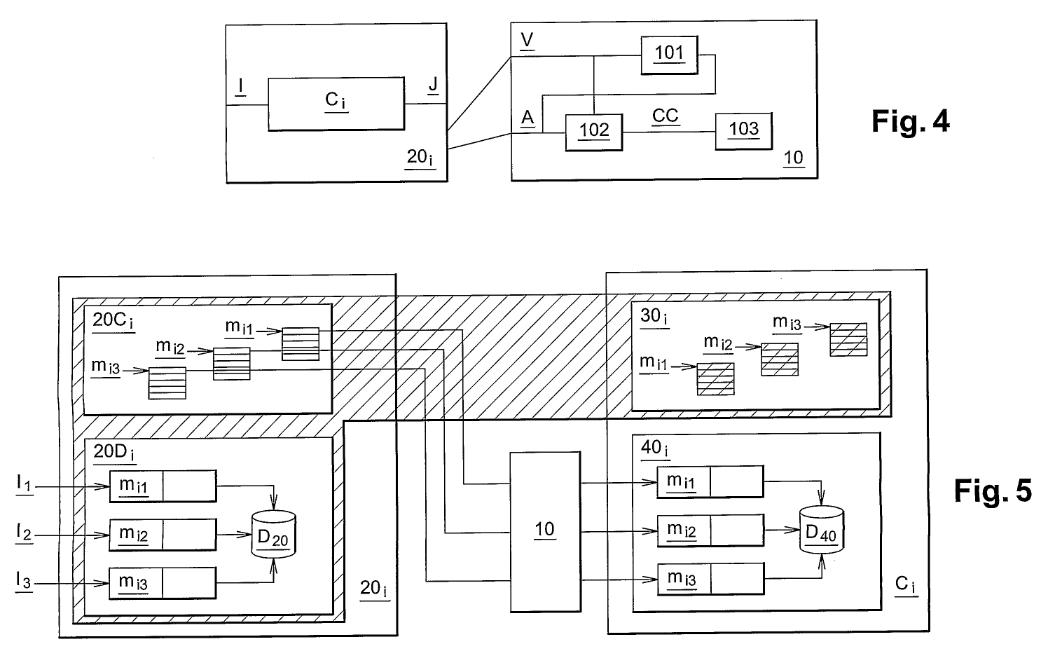

FIG. 4 is a block diagram showing one example of the architecture of a mechanism for protecting a secure object in accordance with the invention;

FIG. 5 is a detailed block diagram of interception means conforming to the invention; and

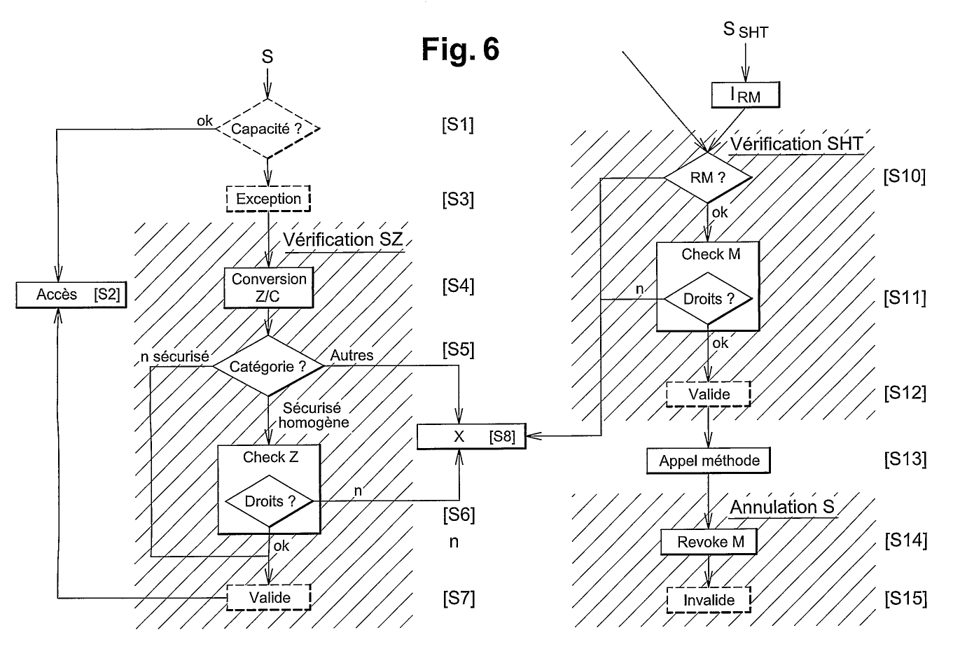

FIG. 6 is a block diagram of an example of an access control method of the invention.

The application selected to illustrate the access control system and method is to a component-based kernel. The components C₁ . . . C_{q} are entities that encapsulate both code 30₁ . . . 30_{q} and data 40₁ . . . 40_{q}. They can be assigned an identity and appear in software systems in the form of execution, configuration and administration, deployment, or mobility units. They enable system designers to control the complexity of software infrastructure implementation and configuration. They interact with their environment via a set of operations, also known as methods, grouped at access points known as interfaces.

FIG. 1 shows a system of the invention for controlling access to objects, whether secured or not, by subjects S for given operations m_{ij, 1≦i≦q}. Those objects C₁ . . . C_{q}, 10, 11_{PA}, 20ₘ₊₁ . . . 20_{q} are passive entities that contain and receive information. In the present example of a component-based kernel, the objects C₁ . . . C_{q}, 10, 11_{PA}, 20ₘ₊₁ . . . 20_{q} are components. The subjects S are active entities that initiate a flow of information between the objects C₁ . . . C_{q}, 10, 11_{PA}, 20ₘ₊₁ . . . 20_{q} and change the state of the system. The access control system includes an access protection mechanism PA for authorizing or denying access by a requesting subject S to an object C₁ . . . C_{q}, 10, 11_{PA}, 20ₘ₊₁ . . . 20_{q} depending on the validity of the corresponding capacity to access said object C₁ . . . C_{q}, 10, 11_{PA}, 20ₘ₊₁ . . . 20_{q}. Access protection can be managed by an object 11_{PA} within the access protection mechanism PA. This access protection management object 11_{PA} groups the access capacities corresponding to each object C₁ . . . C_{q}, 10, 11_{PA}, 20ₘ₊₁ . . . 20_{q} and/or to each operation mᵢⱼ that can be performed on each object. The access control system further includes access control decision means 10 for validating and modifying the validity of the capacities for access to the secured objects Cₙ₊₁ . . . C_{q} as a function of the rights in accordance with the defined security policy of the subject S to access the objects Cₙ₊₁ . . . C_{q}. The access protection mechanism PA implements said decision means 10 if the access capacities are invalid. This access control system clearly separates:
interception by the access protection mechanism PA of an invalid request to access an object C_{i, 1≦i≦q}; and
the decision by the decision means 10, as a function of the security policy, to allocate or not to allocate the access capacity.

The security policy associates with a pair comprising a subject S and an object Cᵢ access rights defining the operations mᵢⱼ that the subject S can effect on the object Cᵢ.

The access control system can further include means 20ₘ₊₁ . . . 20_{q} for intercepting requests to access certain predetermined objects Cₘ₊₁ . . . C_{q}. Respective interception means 20_{i, m+1≦i≦q} are associated with each predetermined object Cᵢ. For the predetermined objects Cₘ₊₁ . . . C_{q}, the control system also clearly separates:
interception by the interception means 20ₘ₊₁ . . . 20_{q} of a request to access one of the predetermined objects Cₘ₊₁ . . . C_{q}; and
the decision by the decision means 10, as a function of the security policy, to allocate or not to allocate the access capacity.

Thus the control system proposes two types of access control: coarse-grain access control by the combination of the access protection mechanism PA and the decision means 10, and fine-grain access control by the combination of the interception means 20ₘ₊₁ . . . 20_{q} and the decision means 10. The decision means 10 are common to coarse-grain and fine-grain access control, enabling the implementation of a unified security policy applicable to the system as a whole.

The objects C₁ . . . . C_{q}, 10, 11_{PA}, 20ₘ₊₁ . . . 20_{q} can be classified into four categories according to the type of access control applied to them (coarse grain, fine grain, hardware control, etc.) and as a function of their security level, as follows:

Control objects 10, 11_{PA}: The objects 10, 11_{PA} in this category manage access control policy and access protection and cannot be accessed by the subjects S that are executed. Thus no access capacity to the control objects 10, 11_{PA} must be created. Accordingly, in the event of access to these control objects, the access protection mechanism PA calls on the decision means 10, which systematically deny access. In the kernel example, these objects or components 10, 11_{PA} are executed in supervisor mode.

Non-secured objects NS {C₁ . . . Cₙ}: Access to these objects C₁ . . . Cₙ is always authorized. In the event of access to them, no verification of access rights is effected and access capacities are always granted. Thus at the time of the first access the access protection mechanism PA calls the decision means 10, which systematically allocate the capacity to access this category of objects NS {C₁ . . . Cₙ}, as shown by the double-headed arrow in chain-dotted line in FIG. 1. Thereafter, the capacity being valid, the decision means 10 are not invoked for the non-secured objects C₁ . . . Cₙ because the capacity to access them is always granted, and therefore automatically validated: the access protection mechanism PA authorizes access to the objects C₁ . . . Cₙ.

Homogeneous secured objects SHM {Cₙ₊₁ . . . Cₘ}: All operations mᵢⱼ on an object Cₙ₊₁ . . . Cₘ have the same access rights. The access decision is taken only once, on the first invocation or on the first access to the data 40ₙ₊₁ . . . 40ₘ of the object. Thus at the time of the first access the access protection mechanism PA calls the decision means 10, which allocate the capacity to access a homogeneous secured object Cₙ₊₁ . . . Cₘ if the access rights allow this (double-headed arrow in dashed line in FIG. 1). Thereafter, if the capacity is valid, the access protection mechanism PA authorizes access to the object. The access capacity remains valid until revoked by the decision means 10.

Heterogeneous secured objects SH7 {Cₘ₊₁ . . . C_{q}}: The operations mᵢⱼ on such an object do not all have the same access rights. An access decision is taken on each invocation Iⱼ. Access control in this category is of finer grain (operation mᵢⱼ level) than access control of homogeneous secured objects (object level). Heterogeneous secured objects can therefore be predetermined objects requests to access which are intercepted by the interception means 20ₘ₊₁ . . . 20_{q}. To prevent illicit access, the access protection mechanism PA is also used for such an object (cf. FIG. 6, steps [S5-S8]). If the subject S addresses the heterogeneous secured object Cₘ₊₁ . . . C_{q} directly, the access protection mechanism PA calls the decision means 10, which systematically maintain the access capacity invalid, as shown by the double-headed arrow in solid line in FIG. 1. Access is not authorized. The interception means 20ₘ₊₁ . . . 20_{q} can therefore not be bypassed. If the subject S addresses the interception means 20ₘ₊₁ . . . 20_{q} to invoke an operation mᵢⱼ on a heterogeneous secured object Cₘ₊₁ . . . C_{q}, the interception means 20ₘ₊₁ . . . 20_{q} call the decision means 10, which allocate or do not allocate a capacity to access the object. If the access capacity has been validated, the interception means 20ₘ₊₁ . . . 20_{q} invoke the operation mᵢⱼ and then again call the decision means 10, which invalidate the access capacity, thereby limiting access by the subject S to the operation mᵢⱼ at the time of subsequent invocations.

The benefit of two secured object categories is that this improves performance because passage through the interception means 20ᵢ can be minimized to the degree that it is not necessary to use the interception means 20ᵢ at all with the homogeneous secured objects Cₙ₊₁ . . . Cₘ. Access is nevertheless verified anyway, by the access protection mechanism PA at least.

The access protection mechanism PA can be a hardware mechanism. In particular, with a kernel, the access protection mechanism PA can be a memory access protection mechanism. A memory area is the smallest contiguous entity of physical memory with which it is possible to associate individually the read or write access rights referred to as access capacities. The access protection mechanism PA must be able to allocate and manipulate access capacities for each memory area and to detect access to memory areas whose access capacities are invalid via an “area defect” exception.

The access capacities are used to detect illicit direct access at object level. This access control is effected by means of the access protection mechanism PA. The memory management unit (MMU) mechanism offered by modern processors satisfies these requirements by assuming that a memory area is similar to a page of the memory management unit MMU and that no distinction is made between virtual addresses and physical addresses. The memory address of a component is therefore the same for all subjects. The memory management unit MMU mechanism is nevertheless costly to use and to implement, mainly in terms of the memory imprint for representing page tables. The access control system of the invention in reality requires only a small portion of the functions offered by this mechanism, in particular access control functions. For representing access capacities, an access protection mechanism PA could therefore content itself with two bits (read and write) rather than the 32 or 64 bits of the memory management units. The access protection mechanism PA would therefore use a table containing 2 bits for each operation on an object, one bit representing the read capacity and the other bit representing the write capacity.

With a component-based kernel, to simplify management of the access protection object 11_{PA}, the components C₁ . . . C_{q}, 10, 11_{PA}, 20ₘ₊₁ . . . 20_{q} in memory can be organized into segments (1, 2, 3, 4₁, . . . 4_{q}), as shown in FIG. 2. A segment is a continuous series of memory areas. The following types of segments in particular can be defined:

A supervisor segment 1 including the code and data of the control components 10 and 11_{PA}. This segment is accessible only in supervisor mode, ensuring complete mediation of the access control system and the integrity of access capacities and rights.

A segment 2 including all the interception means 20ₘ₊₁ . . . 20_{q} whose object is to verify that a call to the decision means 10 really comes from the interception means 20ₘ₊₁ . . . 20_{q}, by checking that the address Mx of the caller's invocation instruction is in fact situated in segment 2. This segment is declared read-only in order to avoid insertion of malicious code into the call sequence and to protect the integrity of the reference to the encapsulated component Cₘ₊₁ . . . C_{q}.

Declaring a segment read-only amounts to allocating it only reading capacities. If a segment is formed of more than one memory area, it is necessary to allocate one capacity for each area.

A segment 3 including the codes 30₁ . . . 30_{q} of the remaining components C₁ . . . C_{q} to prevent violation of the integrity of the code. This segment 3 is declared as read-only.

A segment 4₁ including the data 40₁ . . . 40ₙ of the non-secured components C₁ . . . Cₙ. This segment 4₁ is declared in read mode and in write mode.

For each of the secured components Cₙ₊₁ . . . Cₙ, segments 4ₙ₊₁ . . . 4_{q} including their data 40ₙ₊₁ . . . 40_{q}.

FIG. 3 shows an alternative way of segmenting the set SHM of homogeneous secured components. The data (40ₙ₊₁ . . . 40ⱼ) . . . (40_{I+1} . . . 40ₘ) of the homogeneous components (Cₙ₊₁ . . . Cⱼ) . . . (C_{I+1} . . . Cₘ) subject to the same rights can be grouped in a common segment 4ₙ₊₁ . . . 4_{I+1} and allocated the same capacities. This option optimizes memory by reducing the number of segments, and therefore reduces the number of areas, because a plurality of components can be situated in the same area.

The access control system can in particular be implemented in a flexible component-based operating system such as the “Think” kernel based on the Fractal component-based model described in the paper “Recursive and Dynamic Software Composition with Sharing” by E. Bruneton, T. Coupaye and J. B. Stefani, Seventh International Workshop on Component-Oriented Programming, 2002. The benefit of using a Fractal component-based kernel is that it enables clear separation between the decision means and the access control means, known as a “policy-neutral” approach.

“Think” specifies an interface description language (IDL) for defining the interfaces used by a component Cᵢ. The IDL compiler can be used to generate interception means 20ᵢ for intercepting invocations. To represent the composition of the components Cᵢ, “Think” defines an architecture description language (ADL) for specifying the interfaces provided and required by each component Cᵢ and allocating a security controller to each component Cᵢ, i.e. interception means 20ᵢ for heterogeneous secured components or objects Cₘ₊₁ . . . C_{q}.

“Think” provides the components 11_{PA} for manipulating hardware resources, for example a memory management unit, used to implement the hardware protection access mechanism PA. The allocation of access capacities is reflected in manipulation of permissions at the level of the page tables managed by the memory management unit 11_{PA}.

FIG. 4 is a logical view of the architecture of decision means 10 and interception means 20ᵢ of the control system of the invention. This combination is used to control access to the heterogeneous secured objects SH7. Each heterogeneous secured object C_{i, m+1≦i≦q} is associated with respective interception means 20ᵢ. The interception means 20ᵢ supervise the content of the objects Cᵢ to be protected by filtering incoming calls I. In effect, the role of the interception means 20ᵢ is to intercept invocations I of operations of that object Cᵢ by effecting a call sequence to the decision means 10. The call sequence received by the decision means 10 at the interface V can be as follows:
calling an access rights verification operation (Check M) to verify the right the subject S to access the operation mᵢⱼ of the object Cᵢ (via a supervisor call); and
if the decision means 10 have validated the access capacity, the interception means 20ᵢ calling an operation for revoking that access capacity (Revoke M), execution of that operation making said access capacity invalid.

At the end of invocation, to prevent its re-use in new invocations or on direct access to the data 40ᵢ, the access capacity must be revoked by effecting a call to the operation Revoke M of the decision means 10. This can be achieved by atomic execution of the call sequence, which can be effected by denying dynamic modification of the code 20Cᵢ of the interception means 20_{i.} The decision means 10 therefore export via the interface V (see FIG. 4) two operations Check M and Revoke M which, for the kernel, are effected via a call to the supervisor, because the component including the decision means 10 is a control component. To prevent the application code from usurping rights, only the interception means 20ᵢ can invoke these two operations. The decision means 10 verify if the call to the operations of the interface V in fact emanated from the interception means 20ᵢ in the step [S10] of the process shown in FIG. 6, for example by verifying that the call did in fact emanate from the segment 2 in FIG. 2.

For the “Think” component-based kernel based on the Fractal model, the interception means 20ᵢ are connected to the decision means 10 via two interfaces V and A that are independent of the authorization module. Access control is based on security contexts assigned both to the objects Cᵢ and to the subjects S. The decision means 10 maintain a table of the security contexts of the subjects S and another table of the security contexts of the objects C_{i.} The calculation means 103 calculate permissions as a function of the authorization policy and are held in an access matrix that is managed by the administration means 102.

The component constituting the decision means 10 can therefore include three primitive components:
The administration component 102 that manages the access matrix and the tables of the security contexts of the subjects S and the objects C_{i.} The access matrix is an optimized table of permissions indexed by a pair of security identifiers (subject S, object Cᵢ). The permissions are implemented in the form of bit vectors. Each bit represents the permission associated with an operation mᵢⱼ. The administration component 102 provides an interface A for administering the security policy of the system.
The decision component 101 that decides if the current subject S has the right required to access the object Cᵢ or not. Given the security identifiers of the subject S and the object Cᵢ, the decision component 101 requests the associated access rights from the administration component 102. The decision component 101 then compares the permissions as a function of the target operation mᵢⱼ. It provides an interface V for verifying permissions and assigning access capacities (Check M) and then revoking them (Revoke M).
The permission calculation component 103 that defines the authorization policy. It contains a function that calculates the permissions and fills in the access matrix. Reconfiguring the authorization policy then amounts to replacing this calculation component 103, the administration component 102 and decision component 101 being independent of the model and the authorization policy. This calculation component 103 provides the interface CC that calculates permissions as a function of the model and the access control policy.

The decision means 10 are also solicited by the access protection mechanism PA on detecting access to a memory area whose capacity is invalid, which can arise if the access is illicit or with a homogeneous secured object C_{i, n+1≦i≦m.} The decision means 10 must then determine the access rights of the subject S. If it has the rights, the decision means 10 allocate an access capacity to the subject S, and execution thereof continues. Otherwise, the access capacity remains invalid, access is denied, and execution of the subject S is stopped.

The decision means 10 can also control access to the registers of hardware components such as a network peripheral device, a graphics card, etc. Its interface A includes administrative operations for adding, modifying and eliminating access rights.

A better compromise between high security and reconfigurability is achieved as a result of the synergy resulting from combining the advantages of the component-based approach to obtain an access control mechanism clearly separating the access control decision means and the mechanisms for protecting access to a set of components, secured or not, of an operating system and a hardware memory protection mechanism to prevent bypassing of the access protection mechanism.

FIG. 5 is a block diagram showing in detail the interception means 20ᵢ of the invention. The invocations I₁, I₂ and I₃ (I_{j, j=1 . . . 3}) to the object Cᵢ are intercepted by the interception means 20ᵢ, which execute respective operations mᵢ₁, mᵢ₂ and mᵢ₃ that call the decision means 10, which allocate access or not, enabling execution of these operations on the data of the object Cᵢ where appropriate.

The access control system obtained in this way offers flexible access control for warning a kernel of certain attacks:
injection of malicious code into the access control system;
violation of the integrity of the permissions base 103, the data of the components 40ᵢ or the decision means 10;
bypassing of the decision means 10;
bypassing of the interception means 20ᵢ;
illicit direct access to the data 40ᵢ of the objects by forging references without going through the interfaces.

The access control system is independent of the access control model and policy. It enables dynamic reconfiguration of the authorization policy, in particular by changing the calculation component 103.

FIG. 6 is a block diagram of the access control method of the invention: it summarizes a sequence of steps executed to process a request to access an object C_{i.} This access control method can be executed by the access control system described above.

On starting up, a subject S has no access capacity relating to objects: in an operating system with a component-based kernel, the subject S has no access capacity in relation to the components Cᵢ of the system, to be more precise relative to any memory area. The subject S has to acquire access capacities to the objects that it requires for its execution. Thus if the subject S wishes to access an object for which it does not yet have an access capacity, it requests the decision means 10 to assign it that capacity, either via the interception means 20ᵢ with a heterogeneous secured object C_{i, m+1≦i≦q} or by detecting access to a homogeneous secured object C_{i, n+1≦i≦m} by the access protection mechanism PA (generation of the “area defect” exception). It is therefore possible to distinguish two execution sequences:
The first sequence corresponds to direct access to an object Cᵢ (either invocation Iⱼ of one of its operations mᵢⱼ—which amounts to accessing the data 40ᵢ of the object—or direct access to its data 40ᵢ). A first step [S1] considers whether the subject S already has the corresponding access capacity (in other words, if the access capacity of the subject S to the object Cᵢ is valid). If this is true, the subject S continues to be executed in the normal way, access being authorized in the step [S2]. If they are executed by the access control system, the steps [S1] and [S2] are executed by the access protection mechanism PA, which authorizes access if the capacity is valid. If not, an “area defect” exception is generated in a step [S3] and followed by a verification (SZ verification). If the access control method is executed by the above access control system, in the step [S3] the protection mechanism generates the exception and transfers the execution stream to the exception processor, i.e. to the decision means 10. With an operating system, the processor goes to the supervisor mode. At this stage the object is identified [S5], e.g. by the decision means 10 on the basis of the erroneous address of the area associated with the object. FIG. 6 proposes, by way of example, a step [S4] of area to object conversion (ZC conversion) enabling subsequent identification [S5]. For the four categories of objects proposed above, the access control process continues as follows:
If the object Cᵢ to which access is requested is a non-secured object C_{i, 1≦i≦n}, access is authorized [S2] after allocation of the access capacity [S7].
If the object to which access is requested is a control object 10, 11_{PA}, access to which requires the supervisor mode, access is denied [S8].
If the object to which access is requested is a heterogeneous secured object C_{i, m+1≦i≦q} access is not authorized [S8] because the subject S has bypassed the interception means 20_{i, m+1≦i≦q} (complete mediation violation).
If the object to which access is requested is a homogeneous secured object C_{i, n+1≦i≦m}, an operation Check Z is called to verify the access rights [S6]. If the subject S has rights of access to the object Cᵢ, the capacity is allocated [S7] and access is authorized [S2]. If not, access is denied [S8].

When this method is executed by the above access control system, the decision means 10 verify the category of the object [S5], where appropriate verify the access rights [S6], and where appropriate allocate the capacity for access from the subject S to the requested object Cᵢ [S7], and the access protection mechanism PA authorizes access [S2] or not [S8] depending on the validity of the access capacity.

The second sequence corresponds to a subject S_{SH7} invoking an operation mᵢⱼ on a predetermined object Cᵢ, i.e. an object Cᵢ that has been associated with individual protection means (for example the heterogeneous secured objects Cᵢ having the benefit of the interception means 20ᵢ). The request S_{SH7} must pass through the interception means 20ᵢ, which effect a call I_{RM} (to the supervisor mode of the processor in an application to the operating system in the form of an “SHT verification”) and execute an operation Check M to verify the access rights [S11]. The identification step [S10] is effected first: If the Check M call did not emanate from the interception means 20ᵢ, access is denied [S8]. Otherwise, the operation Check M determines the rights of the subject S_{SH7} to access the operation mᵢⱼ of the object Cᵢ [S11]. If the subject S_{SH7} does not have the required rights, access is denied [S8]. Otherwise, access capacity is allocated [S12]. In an implementation by the above access control system, the decision means 10, which have verified if the call in fact emanated from the interception means 20ᵢ [S10] and have also verified the access rights [S11], call the access protection mechanism PA in order to allocate the capacity [S12] (as shown by the dashed line box illustrating the action of the access protection mechanism PA). The call in supervisor mode terminates after allocation of the capacity (as indicated by the cross-hatched areas in FIG. 6 illustrating the supervisor mode). The interception means 20ᵢ call the required operation mᵢⱼ of the encapsulated object Cᵢ [S13] and then resume control by calling the operation Revoke M [S14]. In the above control system, the operation Revoke M is an operation of the decision means 10 which, in the application to an operating system, is called in supervisor mode (S cancellation). After invalidation of the access capacity, the processor exits the interception means 20ᵢ and returns to user mode.

The invention further consists in a method of fabricating a component-based kernel intended in particular for light operating systems. This component-based kernel includes a flexible access control policy. The fabrication process includes the following steps:
Dividing a system into a plurality of components Cᵢ including code 30ᵢ and data 40ᵢ, each component Cᵢ having one or more interfaces including a set of operations mᵢⱼ that can be effected on the component Cᵢ. It is nevertheless possible to include code or data that is not in the form of components, but such code or data cannot be checked and is treated as non-secured objects.
Defining the security policy and creating a component including access control decision means 10 conforming to that policy, said component including decision means 10 including interfaces with interception means 20ᵢ, with a memory access protection mechanism PA, and, where applicable, with the memory registers of hardware peripheral devices. Said interface V of the decision means with the interception means 20ᵢ includes operations that verify and revoke the rights of a subject S to access a component Cᵢ for a required operation mᵢⱼ.
Classifying the components Cᵢ by the access control type required as a function of the security policy. For example, in accordance with a classification of the objects Cᵢ like that given above: coarse-grain (object level) control is effected for all objects except heterogeneous secured objects, for which fine-grain (operation level) control is effected.
Associating interception means 20ᵢ with each heterogeneous secured component C_{i.} Thus each invocation Iⱼ of an operation mᵢⱼ of the object Cᵢ is intercepted by the interception means 20ᵢ, which call the decision means 10. If the decision means authorize access, the interception means 20ᵢ call the operation mᵢⱼ of the object Cᵢ.
Defining the organization of the memory into segments (for example in accordance with the segmentation described above).
Assembling all the components Cᵢ with the control components 10, 11_{PA}, 20. This can in particular be effected by compilation and link editing.

The access control system of the invention can install secured operating systems without recourse to the addressing concept and is therefore directly applicable to all light terminals. In particular, a component-based kernel with an access control system according to the invention can be used in communication and/or multimedia data broadcasting network operating systems. Generally speaking, the access control method and system according to the invention can be applied to all applications having major security requirements in the terminals, in particular in onboard mobile terminals, or communication and/or broadcasting network intermediate stations, e.g. for applications like e-commerce, digital radio broadcasting (such as DRM for protecting the contents of MP3 players, for example), protection of personal data in medical computing, etc.

1. A system for controlling access by subjects (S) to secured or non-secured objects (C₁ . . . C_{q}, 10, 11_{PA}, 20ₘ₊₁ . . . 20_{q}) for operations (mᵢⱼ), wherein the system comprises an access protection mechanism (PA) for authorizing or denying access by a requesting subject (S) to an object depending on the validity of the corresponding capacity to access said object, and access control decision means (10) for allocating capacities for access to a non-secured object (C₁ . . . Cₙ) and modifying the access capacities of the secured objects (Cₙ₊₁ . . . C_{q}) as a function of the rights of the subject (S) to access the object, said decision means (10) being implemented by the access protection mechanism (PA) if the access capacity is invalid.

2. The access control system according to claim 1, comprising means (20ᵢ) for intercepting requests to access certain predetermined objects (C_{i, m+1≦i≦q}).

3. The access control system according to claim 2, wherein the interception means (20ᵢ) exchange the following sequence of instructions with the access control decision means (10):
to request the access control decision means (10) to verify the intercepted access request;
for the access control decision means (10) to allocate the access capacity or not as a function of the access rights associated with the subject (S) for the requested operation (mᵢⱼ) on said object (Cᵢ);
if the capacity has been validated:
to authorize access to the object (Cᵢ) by the subject (S) for the requested operation (mᵢⱼ);
for the access control decision means (10) to revoke the validity of the access capacity after execution of the operation (mᵢⱼ) requested by the subject (S) on the object (Cᵢ).

4. The access control system according to claim 2, wherein not all operations (mᵢⱼ) of said predetermined object (Cᵢ) have the same access rights.

5. The access control system according to claim 1, wherein the access protection mechanism (PA) is a hardware mechanism.

6. The access control system claim 1, wherein the access protection mechanism (PA) is a table comprising two bits in which one of the bits represents the object or memory management unit read capacities and the other bit represents the object or memory management unit write capacities.

7. The access control system according to claim 1, wherein the access control decision means (10) enable access rights to be added, modified or eliminated.

8. A method of controlling access to objects (Ci) by subjects (S, S_{SH77}) for operations (mᵢⱼ), comprising the steps of:
receiving an access request from the subject (S, S_{SH77});
[S1] protecting access by different means as a function of the validity of the capacity of the subject (S, S_{SH77}) to access the object (Cᵢ) for the requested operation (mᵢⱼ); and
[S6, S11] deciding to allocate the access capacity to the subject (S, S_{SH77}) or not as a function of the right of the subject (S, S_{SH7}) to access the object (Cᵢ) if the capacity is invalid.

9. A method of controlling access to objects (Cᵢ) by subjects (S, S_{SH77} for operations (mᵢⱼ), comprising the steps of:
receiving an access request from the subject (S, S_{SH77});
[S1] protecting access by different means as a function of the validity of the capacity of the subject (S, S_{SH77}) to access the object (Cᵢ) for the requested operation (mᵢⱼ); and
[S6 S11] deciding to allocate the access capacity to the subject (S, S_{SH77}) or not as a function of the right of the subject (S, S_{SH7}) to access the object (Cᵢ) if the capacity is invalid;
wherein the protection step includes:
[S2] if the access capacity is valid, the access protection mechanism (PA) of the access control system according to claim 1 authorizing access;
if the access capacity is invalid and the access request is for direct access to an object (Cᵢ):
[S11] the decision means (10) of the access control system according to claim 1 deciding to allocate the capacity to the subject (S, S_{SH77}) or not as a function of the right of access of the subject (S, S_{SH77}) to access the object (Cᵢ), at the request of the access protection mechanism (PA) of the access control system according to claim 1; and
[S8-S2] the access protection mechanism (PA) of the access control system according to claim 1 authorizing access or denying access as a function of the validity of the capacity for access.

10. The control method according to the claim 9, wherein the protection step includes, if the subject (S, S_{SH77}) requests access for an operation (mᵢⱼ) to an object (Cᵢ) having operations that do not all have the same access rights:
intercepting the access request, enabling invocation (I_{RM}) of an access rights verification;
[S11] verifying the right of the subject (S, S_{SH77}) to access the object (Cᵢ) for the requested operation (mᵢⱼ), enabling a decision to validate the access capacity of the subject (S, S_{SH77}) for said operation (mᵢⱼ) or not;
[S12] authorizing or denying access as a function of the validity of the access capacity; and
if the access request is authorized:
[S13] executing the operation (mᵢⱼ) requested by the subject (S) on the object (Cᵢ); then
[S14] revoking the validity of the capacity of the subject (S) to access the object (Cᵢ) for the requested operation (mᵢⱼ).

11. A component-based kernel, each component (10, 11_{PA}, 20ᵢ, Cᵢ) including code (20Cᵢ, 30ᵢ) and data (20Dᵢ, 40ᵢ), the kernel comprising:
a system according to claim 1, for controlling access to objects including said components (Cᵢ);
control components (10, 11_{PA}) having access capacities that are always invalid, one of said control components including the access control decision means (10) of said access control system;
non-secured components (C_{i, 1≦i≦n}), including objects having access capacities that are always valid;
secured components (C_{i, n+1≦i≦q}), including objects having particular access rights.

12. The component-based kernel according to claim 11, comprising a plurality of segments each including a continuous series of memory areas:
a supervisor segment (1) including the code and data of the control components (10, 11_{PA});
a segment (2) including the interception means (20ᵢ), the access capacities of the objects of this segment being read-only;
a segment (3) of code (30_{i, 1≦i≦q}) of the other components, the access capacities of the objects of this segment being read-only;
a segment (4₁) of data (40_{i, 1≦i≦n}) of the non-secured components (C_{i, 1≦i≦n}), having object access capacities that are in read mode and in write mode;
a segment (4_{1, m+1≦i≦q}) of data (40_{i, m+1≦i≦q}) for each heterogeneous secured component (C_{i, m+1≦i≦q}); and:
either a segment (4_{i, n+1≦i≦m}) of data for each homogeneous secured component (C_{i, n+1≦i≦m});
or a data segment (4ₙ₊₁ . . . 4_{I+1}) for each homogeneous secured component (C_{i, n+1≦i≦m}) having the same access rights.

13. The method of fabricating a component-based kernel according to claim 12, comprising the steps of:
dividing a system into a plurality of components (Cᵢ) including code (30ᵢ), data (40ᵢ) and one or more interfaces including operations (mᵢⱼ);
defining a security policy;
creating a component including access control decision means (10) having interfaces (V, A) with interception means (20ᵢ) and an access protection mechanism (PA), said interface (V) with the interception means (20ᵢ) including operations of verifying and revoking rights of a subject (S_{SH77}) to access a component (Cᵢ);
classifying the components (Cᵢ) by the access control type required as a function of the security policy;
associating respective interception means (20_{i, m+1≦i≦q}) with each heterogeneous secured component (C_{1, m+1≦i≦q});
defining the organization of the memory into segments; and
assembling all the components (Cᵢ) with the control components (10, 11_{PA}).

14. Use of a component-based kernel according to claim 11, in communication network and/or multimedia data broadcasting station operating systems.
